(19) United States
(12) Patent Application Publication
(10) Pub. No.: US 2024/0281501 A1
(43) Pub. Date: Aug. 22, 2024

(54) 3D POINT CLOUD IDENTIFICATION DEVICE, 3D POINT CLOUD IDENTIFICATION METHOD, AND 3D POINT CLOUD IDENTIFICATION PROGRAM

(71) Applicant: NIPPON TELEGRAPH AND TELEPHONE CORPORATION, Tokyo (JP)

(72) Inventors: Kana KURATA, Tokyo (JP); Yasuhiro YAO, Tokyo (JP); Naoki ITO, Tokyo (JP); Jun SHIMAMURA, Tokyo (JP)

(73) Assignee: NIPPON TELEGRAPH AND TELEPHONE CORPORATION, Tokyo (JP)

(21) Appl. No.: 18/292,226

(22) PCT Filed: Jul. 29, 2021
(86) PCT No.: PCT/JP2021/028135

§ 371 Date: Jan. 25, 2024

(51) Int. Cl. G06F 18/241

(52) U.S. Cl. CPC G06F 18/241

(57) ABSTRACT

A three-dimensional point group is accurately identified on the basis of GIS data in which a geographical position of an object is defined by a polygon, a line, or a point.

An initial label assignment unit (101) assigns a label indicating an object or a type of the object corresponding to some three-dimensional points included in a three-dimensional point group to the three-dimensional points on the basis of GIS data indicating a geographical position of the object by a polygon formed by connecting a plurality of coordinate points, a line formed by connecting a plurality of coordinate points, or one coordinate point itself, and an estimation unit (112) estimates a label of three-dimensional points to which the label has not been assigned by propagating the label of the three-dimensional points to which the label has been assigned to the three-dimensional points to which the label has not been assigned based on similarity between the three-dimensional points to which the label has been assigned and the three-dimensional points to which the label has not been assigned.

### TECHNICAL FIELD

The disclosed technology relates to a three-dimensional point group identification device, a three-dimensional point group identification method, and a three-dimensional point group identification program.

### BACKGROUND ART

Data of a point having three-dimensional position information (x, y, z) is referred to as a three-dimensional point. The three-dimensional point can represent a point on a surface of an object. Data including a group of such three-dimensional points is referred to as a three-dimensional point group. The three-dimensional point group is a set of N (N≥2) three-dimensional points, and each three-dimensional point is specified by an identifier of 1 to N. The three-dimensional points included in the three-dimensional point group are points on the surface of the object, and is data indicating geometric information of the object. The three-dimensional point group can be acquired by measurement by a distance sensor or three-dimensional reconstruction from an image.

When a shape of a scene including a plurality of objects such as a town or a room is measured on the basis of observation by Lidar or a stereo image, each three-dimensional point included in the obtained three-dimensional point group may have attribute information. The attribute information is information reflecting the physical properties of the point other than the position information obtained at the time of measuring the three-dimensional point group. Examples of the attribute information include measurement time, an intensity value indicating reflection intensity of a point, and an RGB value indicating color information.

As described above, the three-dimensional point group has attribute information reflecting physical properties, but does not have attribute information reflecting semantic information such as a class label or an instance label. The class label indicates the type of the object represented by the three-dimensional point group. Examples of such a class label include ground, a building, a pillar, a cable, a tree, and the like when an outdoor three-dimensional point group is targeted. The instance label of the three-dimensional point group indicates an individual object represented by the three-dimensional point group. Such an instance label specifies each object, and for example, different labels are applied to different objects even if the objects are of the same type such as “building A” and “building B”.

An operation of identifying each object represented by the three-dimensional point group and giving a semantic boundary to the three-dimensional point group is referred to as identification of the three-dimensional point group. As a specific method of identifying the three-dimensional point group, there is a method of assigning semantic attribute information such as a class label and an instance label to each three-dimensional point in the three-dimensional point group, or extracting a partial point group belonging to each class or each object from the three-dimensional point group.

As a three-dimensional point group identification method, for example, there are a method of assigning a label to each three-dimensional point by visual recognition, a method using an identification model in which a parameter is determined on the basis of training data (for example, Non Patent Literature 1), and the like. In the method as disclosed in Non Patent Literature 1, there is a tendency that an object can be identified with high accuracy, but it is necessary to create training data. The creation of training data generally requires a large amount of cost.

In addition, there is a system called a geographic information system (GIS). The GIS is a technology that comprehensively manages and processes data (spatial data) having information regarding a position using a geographical position as a clue, visually displays the data, and enables advanced analysis and quick determination. In the GIS, data that stores the geographical position of each object is referred to as GIS data. Objects whose geographical positions are stored as GIS data include objects that can be counted one by one, such as buildings, structures that are continuous in a wide range, such as roads, and objects whose physical boundaries are not clear, such as municipal areas. Such objects with geographical positions are referred to as features. The geographical position is represented by a polygon formed by connecting geographical coordinate points, a line formed by connecting geographical coordinates, or a geographical coordinate point. The geographic coordinates in the GIS data are often two-dimensional coordinates that do not include height direction information.

A technology of assigning an instance label to a three-dimensional point group on the basis of a region defined by a polygon included in GIS data as described above has been proposed (for example, Non Patent Literature 2). In the technology disclosed in Non Patent Literature 2, for a plurality of polygons of “gate”, “wall surface”, and “building” included in GIS data generated for a target region, a point group included in each polygon is extracted to identify each object. In such a technology, since object identification based on GIS data is performed, it is not necessary to create training data.

### CITATION LIST

### Non Patent Literature

Non Patent Literature 1: Yangyan Li, Rui Bu, Mingchao Sun, Wei Wu, Xinhan Di, Baoquan Chen, “PointCNN: Convolution On X-Transformed Points”, 32nd Conference on Neural Information Processing Systems (NeurIPS 2018), pp.828-838, 2018.

Non Patent Literature 2: Arnadi Murtiyoso, Pierre Grussenmeyer, “POINT CLOUD SEGMENTATION AND SEMANTIC ANNOTATION AIDED BY GIS DATA FOR HERITAGE COMPLEXES”, 8th International Workshop 3D-ARCH “3D Virtual Reconstruction and Visualization of Complex Architecture”, January 2019, Bergamo, Italy. pp.523-528.

### SUMMARY OF INVENTION

### Technical Problem

In the technology disclosed in Non Patent Literature 2, each object is identified by assigning a label to a three-dimensional point in a region defined by a polygon. In a case where a three-dimensional point group representing a scene of an urban area is identified using this method, for example, an incorrect label may be assigned in the following situation.

The first is a case where an error occurs in the geographical position of the GIS data due to uncorrected variation due to the earth's crust movement or the like, and an error occurs in the label due to a polygon deviating from the observation result of the three-dimensional point group.

The second is a case where an error occurs in the position information of the three-dimensional point group because the reference coordinate that is the basis for determining the geographical position in generating the three-dimensional point group from the observation data by Lidar or the like is incorrect. Also in this case, as in the first case, an error occurs in the label due to deviation of the polygon from the observation result of the three-dimensional point group. As the reference coordinate, for example, a positioning result of a global positioning system (GPS) is used.

A third case is that a label of a part of the object is not assigned because the definition of the geographical position in the GIS data is different from the shape of the actual object. For example, in the GIS data, an object shape is simplified to define a polygon.

FIG. 1 illustrates an example in which a building is identified from a three-dimensional point group in Aoba-ku, Yokohama using GIS data of a building perimeter line class included in infrastructure map information (infrastructure map information site | Geospatial Information Authority of Japan (gsi.go.jp) distributed by Geospatial Information Authority of Japan by the method of Non Patent Literature 2. In FIG. 1, the difference in label (building or other) assigned to the three-dimensional point is represented by the difference in color (density) of the three-dimensional point. The lower left frame of FIG. 1 is a partially enlarged view of the upper view of FIG. 1. As illustrated in FIG. 1, in this example, a part of the building is not correctly identified (for example, a broken-line elliptical portion in FIG. 1).

In the technology of Non Patent Literature 2, it is not possible to identify an object whose geographical position is defined by a point or a line in the GIS data.

The present disclosure has been made in view of the above points, and an object thereof is to provide a three-dimensional point group identification device, a three-dimensional point group identification method, and a three-dimensional point group identification program capable of accurately identifying a three-dimensional point group on the basis of GIS data in which a geographical position of an object is defined by a polygon, a line, or a point.

### Solution to Problem

A first aspect of the present disclosure is a three-dimensional point group identification device including: an assignment unit that assigns a label indicating an object or a type of the object corresponding to some three-dimensional points included in a three-dimensional point group to the three-dimensional points on the basis of data indicating a geographical position of the object by a polygon formed by connecting a plurality of coordinate points, a line formed by connecting a plurality of coordinate points, or one coordinate point itself; and an estimation unit that estimates a label of three-dimensional points to which the label has not been assigned by propagating the label of the three-dimensional points to which the label has been assigned to the three-dimensional points to which the label has not been assigned on the basis of similarity between the three-dimensional points to which the label has been assigned and the three-dimensional points to which the label has not been assigned.

A second aspect of the present disclosure is a three-dimensional point group identification method including: assigning a label indicating an object or a type of the object corresponding to some three-dimensional points included in a three-dimensional point group to the three-dimensional points on the basis of data indicating a geographical position of the object by a polygon formed by connecting a plurality of coordinate points, a line formed by connecting a plurality of coordinate points, or one coordinate point itself, by an assignment unit; and estimating a label of three-dimensional points to which the label has not been assigned by propagating the label of the three-dimensional points to which the label has been assigned to the three-dimensional points to which the label has not been assigned on the basis of similarity between the three-dimensional points to which the label has been assigned and the three-dimensional points to which the label has not been assigned, by an estimation unit.

A third aspect of the present disclosure is a three-dimensional point group identification program for causing a computer to function as each unit constituting the three-dimensional point group identification device described above.

### Advantageous Effects of Invention

According to the disclosed technology, it is possible to accurately identify a three-dimensional point group on the basis of GIS data in which a geographical position of an object is defined by a polygon, a line, or a point.

### BRIEF DESCRIPTION OF DRAWINGS

FIG. 1 is a diagram for explaining a case where there is an error in a label assigned on the basis of GIS data.

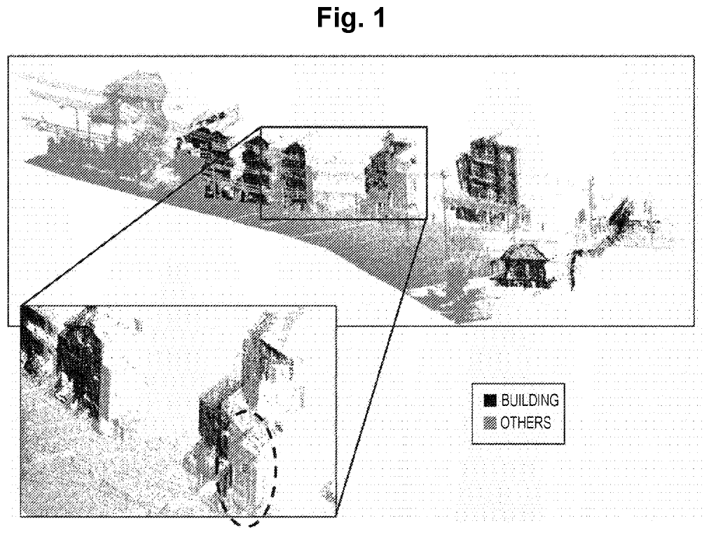

FIG. 2 is a block diagram illustrating a hardware configuration of a three-dimensional point group identification device.

FIG. 3 is a block diagram illustrating an example of a functional configuration of the three-dimensional point group identification device.

FIG. 4 is a flowchart illustrating a flow of three-dimensional point group identification processing.

FIG. 5 is a flowchart illustrating a flow of first initial label assignment processing.

FIG. 6 is a flowchart illustrating a flow of second initial label assignment processing.

FIG. 7 is a flowchart illustrating a flow of third initial label assignment processing.

### DESCRIPTION OF EMBODIMENTS

Hereinafter, an example of an embodiment of the disclosed technique will be described with reference to the drawings. Note that, in the drawings, the same or equivalent components and portions are denoted by the same reference numerals. In addition, dimensional ratios in the drawings are exaggerated for convenience of description, and may be different from actual ratios.

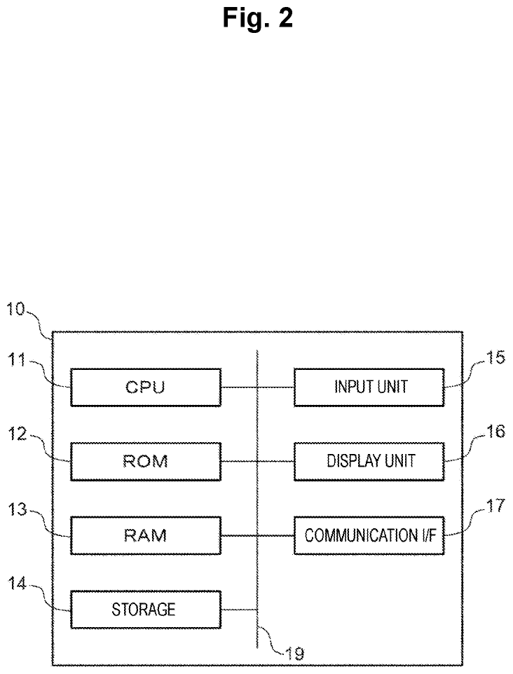

FIG. 2 is a block diagram illustrating a hardware configuration of a three-dimensional point group identification device according to the present embodiment. As illustrated in FIG. 2, a three-dimensional point group identification device 10 includes a central processing unit (CPU) 11, a read only memory (ROM) 12, a random access memory (RAM) 13, a storage 14, an input unit 15, a display unit 16, and a communication interface (I/F) 17. The components are communicatively connected to each other via a bus 19.

The CPU 11 is a central processing unit that executes various programs and controls each unit. That is, the CPU 11 reads a program from the ROM 12 or the storage 14, and executes the program by using the RAM 13 as a work area. The CPU 11 controls each component described above and performs various types of calculation processing according to the program stored in the ROM 12 or the storage 14. In the present embodiment, the ROM 12 or the storage 14 stores a three-dimensional point group identification program for executing three-dimensional point group identification processing to be described later.

The ROM 12 stores various programs and various types of data. The RAM 13 temporarily stores a program or data as a working area. The storage 14 includes a storage device such as a hard disk drive (HDD) or a solid state drive (SSD), and stores various programs including an operating system and various data.

The input unit 15 includes a pointing device such as a mouse and a keyboard, and is used to perform various inputs. The display unit 16 is, for example, a liquid crystal display, and displays various types of information. The display unit 16 may function as the input unit 15 by employing a touchscreen system. The communication I/F 17 is an interface for communicating with other devices. For the communication, for example, a wired communication standard such as Ethernet (registered trademark) or FDDI, or a wireless communication standard such as 4G, 5G, or Wi-Fi (registered trademark) is used.

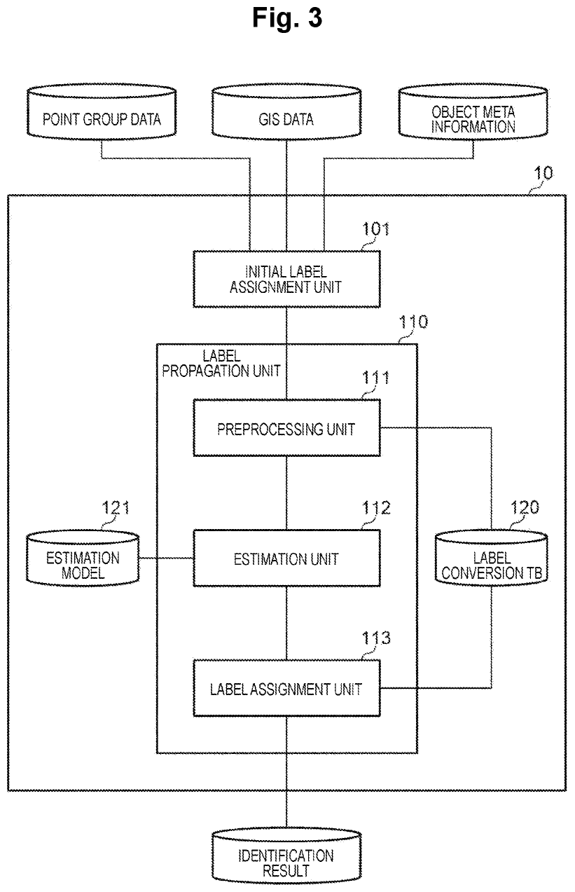

Next, a functional configuration of the three-dimensional point group identification device 10 will be described. FIG. 3 is a block diagram illustrating an example of the functional configuration of the three-dimensional point group identification device 10. As illustrated in FIG. 3, the point group data, the GIS data, and the object meta information are input to the three-dimensional point group identification device 10. The three-dimensional point group identification device 10 performs three-dimensional point group identification processing and outputs an identification result.

The point group data is data of a three-dimensional point group including a group of three-dimensional points having three-dimensional position information (x, y, z) and attribute information. Hereinafter, the point group data is denoted as P, and the i-th point of P is denoted as P[i]. i is a scalar value, and i is referred to as an index of P[i]. A subset of P obtained by extracting a plurality of three-dimensional points from P is denoted as P[I]. I is an index group of the extracted three-dimensional points. When P_I=P[I] is set, an index of each three-dimensional point is common between P and P_I, and when P[i] is included in P_I, P[i]=P_I[i] is satisfied. When the point group data P is projected onto the ground surface and converted into a two-dimensional geographic coordinate group and the result is P′, each three-dimensional point is identified by a common index between P and P′. That is, P′_i is a point at which P_i is projected onto the ground surface.

The (x, y) of the position information represents coordinates of the three-dimensional point on the ground surface. z is the altitude of the three-dimensional point, and represents the position in the vertical direction at (x, y), for example, the altitude. The attribute information is reflection intensity, color information, and the like obtained at the time of three-dimensional point measurement.

The GIS data is data indicating a geographical position of an object by a polygon formed by connecting a plurality of coordinate points, a line formed by connecting a plurality of coordinate points, or one coordinate point itself. Hereinafter, in the GIS data, an object whose geographical position is indicated by a polygon is referred to as a “polygon object”, an object whose geographical position is indicated by a line is referred to as a “line object”, and an object whose geographical position is indicated by a coordinate point itself is referred to as a “point object”. The polygon object is, for example, an object belonging to a class such as a building or a body of water. The line object is, for example, an object belonging to a class such as a railway track or a sidewalk. The point object is, for example, a small object belonging to a class such as a road accessory such as a utility pole or a traffic light.

The geographic coordinates in the GIS data are described as a set of two values (latitude, longitude) or (X, Y) in the geographic coordinate system. It is assumed that each object included in the GIS data is assigned a class label representing a type of the object, that is, a class to which the object belongs, in addition to the information of the geographical position described above. In a case where the GIS data includes an object to which no class label has been assigned, a class label may be assigned on the basis of another information such as an object name or another attribute value that can specify a class.

The object meta information is information in which a general size of an object is associated with each type of the object.

As illustrated in FIG. 3, the three-dimensional point group identification device 10 includes an initial label assignment unit 101 and a label propagation unit 110 as functional configurations. The label propagation unit 110 includes a preprocessing unit 111, an estimation unit 112, and a label assignment unit 113. A label conversion table (TB) 120 and an estimation model 121 are stored in a predetermined storage area of the three-dimensional point group identification device 10. The initial label assignment unit 101 is an example of an assignment unit of the disclosed technology. Each functional configuration is achieved in a case where the CPU 11 reads the position detection program stored in the ROM 12 or the storage 14, loads the position detection program in the RAM 13, and executes the three-dimensional point group identification program.

The initial label assignment unit 101 acquires the point group data, the GIS data, and the object meta information input to the three-dimensional point group identification device 10. The initial label assignment unit 101 assigns a class label indicating the type of the object corresponding to the three-dimensional point, to some of the three-dimensional points included in the point group data, on the basis of the GIS data. Hereinafter, the label assigned by the initial label assignment unit 101 is also referred to as an “initial label”.

Specifically, the initial label assignment unit 101 associates geographic coordinates of the GIS data with position information of the point group data. Then, the initial label assignment unit 101 assigns the class label assigned to the polygon object as an initial label to the three-dimensional point included in the polygon (hereinafter, referred to as a “first polygon”) indicating the geographical position of the polygon object included in the GIS data. The initial label assignment unit 101 assigns the class label assigned to the line object as an initial label to the three-dimensional point included in the polygon (hereinafter, referred to as a “second polygon”) with reference to a line indicating the geographical position of the line object included in the GIS data. The initial label assignment unit 101 assigns the class label assigned to the point object as an initial label to the three-dimensional point included in the polygon (hereinafter, referred to as a “third polygon”) with reference to the coordinate point itself, the coordinate point indicating the geographical position of the point object included in the GIS data.

As described above, since the geographic coordinates of the GIS data are two-dimensional coordinates, the initial label assignment unit 101 calculates a two-dimensional point obtained by projecting the coordinates of each three-dimensional point of the point group data onto the two-dimensional coordinates. When the two-dimensional point is included in the first polygon, the second polygon, or the third polygon, an initial label is assigned to the three-dimensional point corresponding to the two-dimensional point.

The Initial label assignment unit 101 may determine four points separated by the first distance in the direction orthogonal to the line from each of the start point and the end point of the line indicating the geographical position of the line object, and generate the second polygon as a polygon connecting the determined four points. The initial label assignment unit 101 may determine a predetermined number (for example, eight) of points separated from the coordinate point itself indicating the geographical position of the point object by the second distance in different directions, and generate the third polygon as a polygon connecting the determined predetermined number of points. At this time, for example, the initial label assignment unit 101 sets the first distance and the second distance to ½ or less of the size indicated by the object meta information as the size of the corresponding line object or point object. As a result, it is possible to avoid that the second polygon and the third polygon become unnecessarily too large with respect to the actual object, and it is possible to exclude a three-dimensional point that becomes noise as a three-dimensional point to be subjected to initial label processing.

The initial label assignment unit 101 may assign an initial label to a three-dimensional point extracted by filtering according to a feature of a corresponding object from three-dimensional points included in the first polygon, the second polygon, or the third polygon. For example, the initial label assignment unit 101 extracts a three-dimensional point whose altitude or attribute value is included in a range with a standard deviation as a margin around the altitude (z) of the three-dimensional point included in the first polygon, the second polygon, or the third polygon or the average of the attribute values of any attribute information. The initial label assignment unit 101 assigns an initial label to the extracted three-dimensional point. Accordingly, a highly reliable initial label can be assigned.

The initial label assignment unit 101 assigns initial labels to a small number of points so that the number per class is as uniform as possible among the objects to be identified (hereinafter, referred to as a “target object”) included in the scene represented by the point group data. For example, the initial label assignment unit 101 may set one object for each class as an initial label assignment target. The initial label assignment unit 101 passes the point group data including three-dimensional points to which the initial label has been assigned and three-dimensional points to which the label has not been assigned to the label propagation unit 110.

The label propagation unit 110 identifies the point group data by using the label propagation technology with respect to the point group data in which the initial label is assigned to some three-dimensional points on the basis of the GIS data. As the label propagation technology, for example, the technology of Reference Literature 1 below may be used. The technology of Reference Literature 1 is a technology of identifying a point group by assigning several correct initial labels in the point group and propagating the labels to surrounding points having high similarity in three-dimensional coordinates and shape features.

Reference Literature 1: Yao, Y., Xu, K., Murasaki, K. et al. “Pseudo-labelling-aided semantic segmentation on sparsely annotated 3D point clouds”, IPSJ T Comput Vis Appl 12, 2 (2020). https://doi.org/10.1186/s41074-020-00064-w

Hereinafter, the preprocessing unit 111, the estimation unit 112, and the label assignment unit 113 will be described on the assumption that the technology of Reference Literature 1 is applied.

The preprocessing unit 111 excludes a class label indicating an object other than the target object from the initial label. For example, it is assumed that, in a case where it is desired to identify a building and a road from the point group data, “building”, “road”, and “utility pole” are assigned as initial labels by the initial label assignment unit 101. In this case, the preprocessing unit 111 excludes the initial label “pole”. Specifically, the preprocessing unit 111 creates one class (for example, “others”) in which objects other than the target object are collected, and changes a class label indicating an object other than the target object in the initial labels to the class label “others”. At this time, the preprocessing unit 111 may change some of the class labels selected from the class labels indicating the objects other than the target object among the initial labels so that the initial labels are assigned to the same number of three-dimensional points in the class “others” and each class of the target object. The preprocessing unit 111 excludes a class label indicating an object other than the target object that has not been selected, from the initial label. In a case where some of the selected class labels are changed, the preprocessing unit 111 selects three-dimensional points of portions having different shapes as much as possible. As a result, erroneous identification can be suppressed.

In addition, the preprocessing unit 111 refers to a label conversion TB 120 and converts the initial label assigned to some of the three-dimensional points into an integer value. The label conversion TB 120 is, for example, a table defining a conversion rule between a class label represented by text data and a class label represented by an integer value. For example, the label conversion TB 120 stores conversion rules such as “building: 1” and “road: 2”.

The estimation unit 112 propagates the initial label (class label) of the three-dimensional point to which the initial label has been assigned to the three-dimensional point to which the class label has not been assigned on the basis of the similarity between the three-dimensional point to which the initial label is assigned and the three-dimensional point to which the initial label has not been assigned. As a result, the estimation unit 112 estimates the class label of the three-dimensional point to which the initial label has not been assigned.

Specifically, the estimation unit 112 learns the parameters of the estimation model 121 configured by, for example, a deep neural network or the like using the position information and the attribute information of the three-dimensional point to which the initial label has been assigned as the feature amount and the initial label as the correct label. Then, the estimation unit 112 inputs the position information and the attribute information of the three-dimensional point to which the initial label has not assigned to the estimation model 121 in which the parameter has been learned, and obtains an output of the estimated class label (integer value). The estimation unit 112 passes the estimation result to the label assignment unit 113.

The label assignment unit 113 refers to the label conversion TB 120 and converts the class label expressed by the integer value into the class label of the original expression. The label assignment unit 113 outputs, as an identification result, the point group data obtained by assigning the converted class label to each of the three-dimensional points.

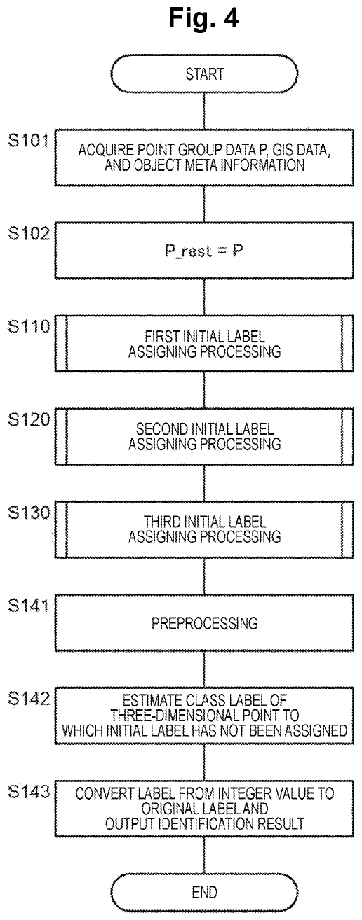

Next, an operation of the three-dimensional point group identification device 10 will be described. FIG. 4 is a flowchart illustrating a flow of three-dimensional point group identification processing by the three-dimensional point group identification device 10. The three-dimensional point group identification processing is performed by the CPU 11 reading a three-dimensional point group identification program from the ROM 12 or the storage 14, developing the identification program in the RAM 13, and executing the three-dimensional point group identification program.

In step S101, the CPU 11, as the initial label assignment unit 101, acquires the point group data P, the GIS data, and the object meta information input to the three-dimensional point group identification device 10.

Next, in step S102, the CPU 11, as the initial label assignment unit 101, sets the point group data P to P rest representing a set of three-dimensional points to which the initial label has not been applied.

Next, in step S110, first initial label assignment processing is performed. Next, in step S120, second initial label assignment processing is performed. Next, in step S130, third initial label assignment processing is performed. Hereinafter, each of the first initial label assignment processing, the second initial label assignment processing, and the third initial label assignment processing will be described in detail.

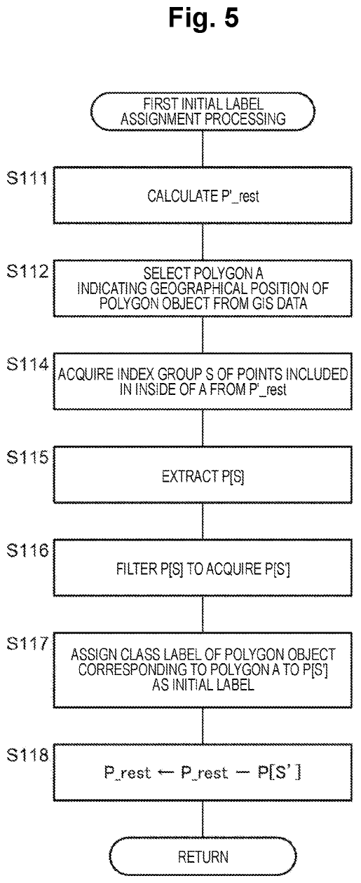

FIG. 5 is a flowchart illustrating a flow of the first initial label assignment processing. The first initial label assignment processing is processing of assigning an initial label from the polygon object included in the GIS data. When a region between a plurality of lines such as a road is set as a target object, this processing can be applied similarly to the polygon object by combining the line objects of the GIS to create a polygon.

In step S111, the CPU 11, as the initial label assignment unit 101, projects the coordinates of each three-dimensional point of P_rest onto the ground surface, and calculates P′_rest converted into a two-dimensional geographic coordinate group. Next, in step S112, the CPU 11, as the initial label assignment unit 101, selects a polygon A (first polygon) indicating the geographical position of the polygon object from the GIS data.

Next, in step S114, the CPU 11, as the initial label assignment unit 101, extracts a point included in the inside of the polygon A among points included in P′_rest, and acquires S that is an index group of the extracted points. S includes a plurality of indexes. Next, in step S115, the CPU 11, as the initial label assignment unit 101, extracts a partial point group P[S] whose index corresponds to S from P.

Next, in step S116, the CPU 11, as the initial label assignment unit 101, performs filtering on P[S] according to the characteristics of the polygon object corresponding to the polygon A. For example, when the class is a polygon object belonging to a building, the CPU 11, as the initial label assignment unit 101, sets the average of the altitudes of the three-dimensional points included in P[S] as p and the standard deviation as o. Then, the CPU 11, as the initial label assignment unit 101, acquires P[S′] obtained by leaving only three-dimensional points having an altitude in the range of μ−σ to μ+σ and excluding non-corresponding three-dimensional points from P[S]. For example, when the class is a polygon object belonging to a road, the CPU 11, as the initial label assignment unit 101, sets the average of the luminance (reflection intensity) of the three-dimensional points included in P[S] as σ and the standard deviation as σ. Then, the CPU 11, as the initial label assignment unit 101, acquires P[S′] obtained by leaving only three-dimensional points having luminance in the range of μ−σ to μ+σ and excluding non-corresponding three-dimensional points from P[S].

Next, in step S117, the CPU 11, as the initial label assignment unit 101, assigns the class label assigned to the polygon object corresponding to the polygon A, to each three-dimensional point included in P[S′]. Next, in step S118, the CPU 11, as the initial label assignment unit 101, newly sets P_rest by removing P[S′] from P_rest. Then, the first initial label assignment processing ends, and the process returns to the three-dimensional point group identification processing (FIG. 4).

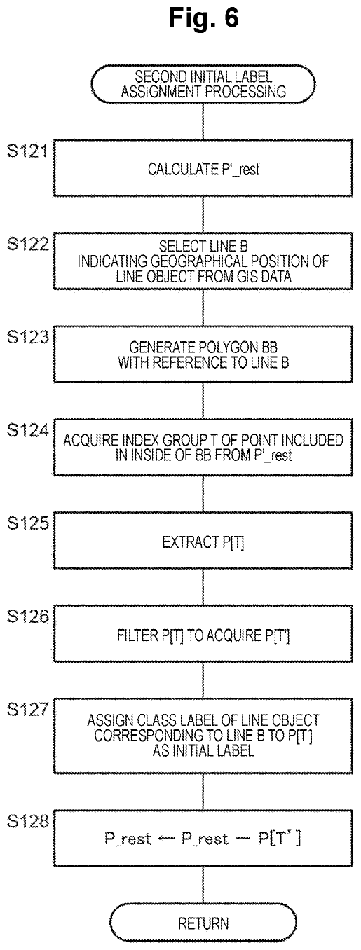

FIG. 6 is a flowchart illustrating a flow of the second initial label assignment processing. The second initial label assignment processing is processing of assigning an initial label from the line object included in the GIS data. In the second initial label assignment processing, a detailed description of similar processing to the first initial label assignment processing will be omitted.

Next, in step S121, the CPU 11, as the initial label assignment unit 101, calculates P′_rest from P_rest. Next, in step S122, the CPU 11, as the initial label assignment unit 101, selects a line B indicating the geographical position of the line object from the GIS data.

Next, in step S123, the CPU 11, as the initial label assignment unit 101, generates a polygon BB (second polygon) around B. For example, the CPU 11, as the initial label assignment unit 101, determines a total of four points including two points separated by a certain distance b_dist (first distance) in a direction orthogonal to the direction of B from each of the start point and the end point of B. Then, the CPU 11, as the initial label assignment unit 101, sets a polygon generated by connecting the determined four points as BB. As described above, b_dist is ½ or less of the size of the line object corresponding to the line B.

Next, in step S124, the CPU 11, as the initial label assignment unit 101, extracts a point included in the inside of the polygon BB among points included in P′_rest, and acquires T that is an index group of the extracted points. T includes a plurality of indexes. Hereinafter, in step S125 to 128, the similar processing is performed by replacing “S” in step S115 to 118 of the first initial label assignment processing with “T”, the second initial label assignment processing ends, and the process returns to the three-dimensional point group identification processing (FIG. 4).

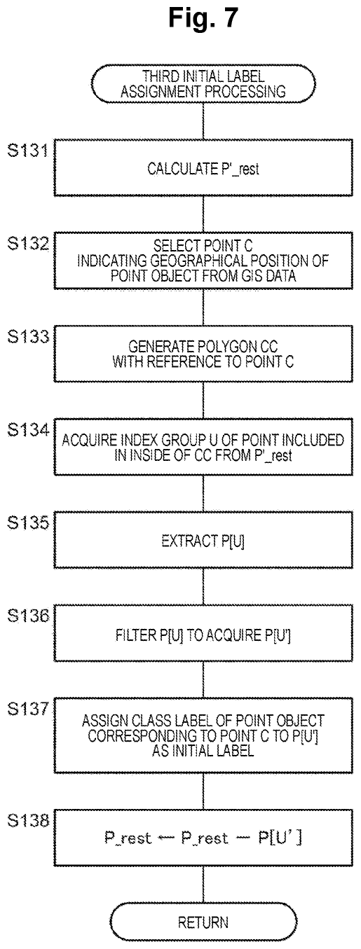

FIG. 7 is a flowchart illustrating a flow of the third initial label assignment processing. The third initial label assignment processing is processing of assigning an initial label from the point object included in the GIS data. In the third initial label assignment processing, a detailed description of similar processing to the first initial label assignment processing will be omitted.

Next, in step S131, the CPU 11, as the initial label assignment unit 101, calculates P′_rest from P_rest. Next, in step S132, the CPU 11, as the initial label assignment unit 101, selects a point C indicating the geographical position of the point object from the GIS data.

Next, in step S133, the CPU 11, as the initial label assignment unit 101, generates a polygon CC (third polygon) around C. For example, the CPU 11 determines, as the initial label assignment unit 101, eight points that are away from C by a certain distance c_dist (second distance). Then, the CPU 11, as the initial label assignment unit 101, sets a polygon generated by connecting the determined eight points as CC. As described above, c_dist is ½ or less of the size of the point object corresponding to the point C.

Next, in step S134, the CPU 11, as the initial label assignment unit 101, extracts a point included in the inside of the polygon CC among points included in P′_rest, and acquires U that is an index group of the extracted points. U includes a plurality of indexes. Hereinafter, in step S135 to 138, the similar processing is performed by replacing “S” in step S115 to 118 of the first initial label assignment processing with “U”, the third initial label assignment processing ends, and the process returns to the three-dimensional point group identification processing (FIG. 4).

In the processing so far, the class label of the class to which the object belongs is assigned as the initial label to a part of the three-dimensional point corresponding to the object (feature) in the GIS data included in the geographical range of the scene represented by the point group data P. A plurality of initial labels is not assigned to one three-dimensional point.

Next, in step S141, the CPU 11, as the preprocessing unit 111, receives the point group data including the three-dimensional point to which the initial label is assigned by the initial label assignment unit 101 and the three-dimensional point to which the label is not assigned. Then, the CPU 11 performs, as the preprocessing unit 111, preprocessing such as exclusion of an initial label indicating an object other than the target object and conversion of the initial label into an integer value.

Next, in step S142, the CPU 11 estimates, as the estimation unit 112, the class label of the three-dimensional point to which the initial label has not been assigned from the three-dimensional point to which the initial label has been assigned by using the estimation model 121, and passes the estimation result to the label assignment unit 113.

Next, in step S143, the CPU 11, as the label assignment unit 113, converts the initial label represented by an integer value and the class label which is the estimation result passed from the estimation unit 112 into the class label of the original expression with reference to the label conversion TB 120. The CPU 11, as the label assignment unit 113, outputs, as an identification result, the point group data obtained by assigning the converted class label to each of the three-dimensional points, and ends the three-dimensional point group identification processing.

As described above, the three-dimensional point group identification device acquires point group data as a set of the three-dimensional points and the GIS data indicating a geographical position of an object by a polygon formed by connecting a plurality of coordinate points, a line formed by connecting a plurality of coordinate points, or one coordinate point itself. The three-dimensional point group identification device assigns a class label indicating the type of the object corresponding to the three-dimensional point, to some of the three-dimensional points included in the point group data, on the basis of the GIS data. The three-dimensional point group identification device propagates the label of the three-dimensional point to which the initial label has been assigned to the three-dimensional point to which the initial label has not been assigned on the basis of the similarity between the three-dimensional point to which the initial label is assigned and the three-dimensional point to which the initial label has not been assigned. As a result, the three-dimensional point group identification device estimates the class label of the three-dimensional point to which the initial label has not been assigned. Therefore, even when there is a positional deviation smaller than the size of the target object between the GIS data and the point group data, when the fine shape of the feature is not reflected in the polygon of the GIS data, and when the geographical position is defined by a line or a point, the three-dimensional point group can be accurately identified on the basis of the GIS data.

In the above embodiment, a case where a class label is assigned has been described as an example, but the disclosed technology is also applicable to a case where an instance label is assigned. In the case of assigning the instance label, the instance label may be assigned to some three-dimensional points of the point group data on the basis of the GIS data when the initial label is assigned. Then, a label propagation technology capable of estimating an instance label is applied to point group data including a three-dimensional point to which an instance label has been assigned as an initial label and a three-dimensional point to which the instance label has not been assigned. As a result, it is sufficient to estimate the instance label of the three-dimensional point to which the instance label has not been assigned.

Note that the three-dimensional point group identification processing executed in a case where the CPU reads software (program) in the embodiment may be executed by various processors other than the CPU. Examples of the processors in this case include a programmable logic device (PLD) of which a circuit configuration can be changed after manufacturing, such as a field-programmable gate array (FPGA), and a dedicated electric circuit that is a processor having a circuit configuration exclusively designed for executing specific processing, such as an application specific integrated circuit (ASIC). In addition, the three-dimensional point group identification processing may be executed by one of these various processors, or may be performed by a combination of two or more processors of the same type or different types (for example, a plurality of FPGAs, a combination of a CPU and an FPGA, and the like). Further, a hardware structure of the various processors is, more specifically, an electric circuit in which circuit elements such as semiconductor elements are combined.

Further, in each of the above embodiments, the aspect in which the three-dimensional point group identification program is stored (installed) in advance in the ROM 12 or the storage 14 has been described, but the present embodiment is not limited thereto. The program may be provided in a form of a program stored in a non-transitory storage medium such as a compact disk read only memory (CD-ROM), a digital versatile disk read only memory (DVD-ROM), or a Universal Serial Bus (USB) memory. Alternatively, the program may be downloaded from an external device via a network.

With regard to above embodiment, the following supplements are further disclosed.

(Supplementary Note 1)

A three-dimensional point group identification device including:
a memory, and
at least one processor connected to the memory,
in which the processor is configured to:
assign a label indicating an object or a type of the object corresponding to some three-dimensional points included in a three-dimensional point group to the three-dimensional points on the basis of data indicating a geographical position of the object by a polygon formed by connecting a plurality of coordinate points, a line formed by connecting a plurality of coordinate points, or one coordinate point itself; and estimate a label of three-dimensional points to which the label has not been assigned by propagating the label of the three-dimensional points to which the label has been assigned to the three-dimensional points to which the label has not been assigned on the basis of similarity between the three-dimensional points to which the label has been assigned and the three-dimensional points to which the label has not been assigned.

(Supplementary Note 2)

A non-transitory recording medium storing a program that can be executed by a computer to execute three-dimensional point group identification processing,
in which the three-dimensional point group identification processing includes:
assigning a label indicating an object or a type of the object corresponding to some three-dimensional points included in a three-dimensional point group to the three-dimensional points on the basis of data indicating a geographical position of the object by a polygon formed by connecting a plurality of coordinate points, a line formed by connecting a plurality of coordinate points, or one coordinate point itself; and estimating a label of three-dimensional points to which the label has not been assigned by propagating the label of the three-dimensional points to which the label has been assigned to the three-dimensional points to which the label has not been assigned on the basis of similarity between the three-dimensional points to which the label has been assigned and the three-dimensional points to which the label has not been assigned.

### REFERENCE SIGNS LIST

10 Three-dimensional point group identification device
11 CPU
12 ROM
13 RAM
14 Storage
15 Input unit
16 Display unit
17 Communication I/F
19 Bus
101 Initial label assignment unit
110 Label propagation unit
111 Preprocessing unit
112 Estimation unit
113 Label assignment unit
120 Label conversion TB
121 Estimation model

1. A three-dimensional point group identification device comprising a processor configured to execute operations comprising:
assigning a first label indicating an object or a type of the object corresponding to a first three-dimensional point included in a three-dimensional point group to the first three-dimensional point based on data indicating a geographical position of the object by at least one of: a polygon formed by connecting at least a plurality of coordinate points, a line formed by connecting a plurality of coordinate points, or one coordinate point itself; and
estimating a second label of a second three-dimensional point to which the first label has not been assigned by propagating the first label of the first three-dimensional points to which the first label has been assigned to the second three-dimensional points to which the first label has not been assigned based on similarity between the first three-dimensional points to which the first label has been assigned and the second three-dimensional point to which the first label has not been assigned.

2. The three-dimensional point group identification device according to claim 1, wherein the assigning further comprises assigning the first label indicating an object or a type of the object corresponding to a first polygon, a second polygon, or a third polygon including a three-dimensional point to the first three-dimensional point included in the first polygon formed by connecting the plurality of coordinate points, the second polygon based on the line, or the third polygon based on the coordinate point itself.

3. The three-dimensional point group identification device according to claim 2, wherein the assigning further comprises, in a case where the coordinate point is of two-dimensional coordinates, when a two-dimensional point obtained by projecting coordinates of the first three-dimensional point onto two-dimensional coordinates is included in the first polygon, the second polygon, or the third polygon, assigning the first label to the first three-dimensional point corresponding to the two-dimensional point.

4. The three-dimensional point group identification device according claim 2, wherein the assigning further comprises assigning the first label to the first three-dimensional point extracted by filtering according to a feature of a corresponding object from three-dimensional points included in the first polygon, the second polygon, or the third polygon.

5. The three-dimensional point group identification device according to claim 4, wherein the assigning further comprises setting, the first three-dimensional point extracted by the filtering, as a three-dimensional point whose altitude or attribute value is included in a range with a standard deviation as a margin around an average of altitudes or attribute values of the three-dimensional points included in the first polygon, the second polygon, or the third polygon.

6. The three-dimensional point group identification device according to claim 2,
wherein the assigning further comprises:
determining the second polygon, as a polygon connecting four points separated by a first distance in a direction orthogonal to the line from each of a start point and an end point of the line,
determining the third polygon, as a polygon connecting a predetermined number of points separated from the coordinate point itself by a second distance in different directions, and
setting the first distance and the second distance to ½ or less of a size predetermined as a size of the object.

7. A computer implemented method for identifying a three-dimensional point group, comprising:
assigning a first label indicating an object or a type of the object corresponding to a first three-dimensional point included in a three-dimensional point group to the first three-dimensional point based on data indicating a geographical position of the object by at least one of: a polygon formed by connecting a plurality of coordinate points, a line formed by connecting a plurality of coordinate points, or one coordinate point itself; and
estimating a second label of a second three-dimensional point to which the first label has not been assigned by propagating the first label of the first three-dimensional point to which the first label has been assigned to the first three-dimensional point to which the first label has not been assigned based on similarity between the first three-dimensional point to which the first label has been assigned and the second three-dimensional point to which the label has not been assigned.

8. A computer-readable non-transitory recording medium storing a computer-executable program instructions that when executed by a processor cause a computer system to execute operations comprising:
assigning a first label indicating an object or a type of the object corresponding to a first three-dimensional point included in a three-dimensional point group to the first three-dimensional point based on data indicating a geographical position of the object by at least one of: a polygon formed by connecting at least a plurality of coordinate points, a line formed by connecting a plurality of coordinate points, or one coordinate point itself; and
estimating a second label of a second three-dimensional point to which the first label has not been assigned by propagating the first label of the first three-dimensional points to which the first label has been assigned to the second three-dimensional points to which the first label has not been assigned based on similarity between the first three-dimensional points to which the first label has been assigned and the second three-dimensional point to which the first label has not been assigned.

9. The three-dimensional point group identification device according to claim 3, wherein the assigning further comprises assigning the first label to the first three-dimensional point extracted by filtering according to a feature of a corresponding object from three-dimensional points included in the first polygon, the second polygon, or the third polygon.

10. The computer implemented method according to claim 7, wherein the assigning further comprises assigning the first label indicating an object or a type of the object corresponding to a first polygon, a second polygon, or a third polygon including a three-dimensional point to the first three-dimensional point included in the first polygon formed by connecting the plurality of coordinate points, the second polygon based on the line, or the third polygon based on the coordinate point itself.

11. The computer implemented method according to claim 10, wherein the assigning further comprises, in a case where the coordinate point is of two-dimensional coordinates, when a two-dimensional point obtained by projecting coordinates of the first three-dimensional point onto two-dimensional coordinates is included in the first polygon, the second polygon, or the third polygon, assigning the first label to the first three-dimensional point corresponding to the two-dimensional point.

12. The computer implemented method according to claim 10, wherein the assigning further comprises assigning the first label to the first three-dimensional point extracted by filtering according to a feature of a corresponding object from three-dimensional points included in the first polygon, the second polygon, or the third polygon.

13. The computer implemented method according to claim 12, wherein the assigning further comprises setting, the first three-dimensional point extracted by the filtering, as a three-dimensional point whose altitude or attribute value is included in a range with a standard deviation as a margin around an average of altitudes or attribute values of the three-dimensional points included in the first polygon, the second polygon, or the third polygon.

14. The computer implemented method according to claim 10, wherein the assigning further comprises:
determining the second polygon, as a polygon connecting four points separated by a first distance in a direction orthogonal to the line from each of a start point and an end point of the line,
determining the third polygon, as a polygon connecting a predetermined number of points separated from the coordinate point itself by a second distance in different directions, and
setting the first distance and the second distance to ½ or less of a size predetermined as a size of the object.

15. The computer-readable non-transitory recording medium according to claim 8, wherein the assigning further comprises assigning the first label indicating an object or a type of the object corresponding to a first polygon, a second polygon, or a third polygon including a three-dimensional point to the first three-dimensional point included in the first polygon formed by connecting the plurality of coordinate points, the second polygon based on the line, or the third polygon based on the coordinate point itself.
